(19) United States
(12) Patent Application Publication
(10) Pub. No.: US 2019/0040781 A1
(43) Pub. Date: Feb. 7, 2019

(54) LIGHTWEIGHT FLOW HEAT EXCHANGER

(71) Applicant: Hanon Systems, Daejeon (KR)

(72) Inventors: Andreas Capelle, Pulheim (DE); Oliver Fischer, Aachen (DE); Peter Diehl, Koeln (DE); Petr Sispera, Uhersky Ostroh (CZ); Juergen Nothbaum, Aachen (DE)

(21) Appl. No.: 16/158,804

(22) Filed: Oct. 12, 2018

Related U.S. Application Data
(63) Continuation of application No. 12/171,392, filed on Jul. 11, 2008.

(30) Foreign Application Priority Data
Jul. 11, 2007 (DE) 102007032238.2
Jul. 11, 2007 (DE) 102007032330.3
Jul. 11, 2007 (DE) 102007032331.1
May 8, 2008 (DE) 102008001660.8

(51) Int. Cl. F01N 5/02; F02M 26/32; F02M 26/11; F28F 1/08

(52) U.S. Cl. CPC F01N 5/02; F02M 26/32; F02M 26/11; F28D 21/0003; F28F 1/08; Y02T 10/16

(57) ABSTRACT

A heat exchanger is disclosed for the exhaust gas train of a motor vehicle with an exhaust gas carrying exchanger tube that is formed separately and is disposed in a closed housing formed separately, a coolant flowing through the housing and around the outer side of the exchanger tube. The housing forms at least one housing cover and one housing case, the housing case being tightly closed by the housing cover. Both ends of the exchanger tube are conducted for gas and liquid tight connection through the housing cover so that the inlet and the outlet of the exchanger tube are disposed outside of the housing.

### CROSS-REFERENCE TO RELATED APPLICATION

This application is a continuation of U.S. patent application Ser. No. 12/171,392 filed on Jul. 11, 2008, which claims the benefit of German patent application serial no. DE 102007032238.2 filed Jul. 11, 2007, German patent application serial no. DE 102007032330.3 filed Jul. 11, 2007, German patent application serial no. DE 102007032331.1 filed Jul. 11, 2007 and German patent application serial no. DE 102008001660.8 filed May 8, 2008 each of which is hereby incorporated herein by reference in its entirety.

### FIELD OF THE INVENTION

The present invention relates to a heat exchanger for an exhaust train of a motor vehicle, and more specifically to an exhaust gas recirculation system for an internal combustion engine of a motor vehicle.

### BACKGROUND OF THE INVENTION

Due to the ever more stringent legal regulations regarding exhaust emission of motor vehicles, in particular regarding emission of nitrogen oxides, recirculation of combustion exhaust on the inlet side of the internal combustion engine is state of the art in the field of internal combustion engines. The combustion gases themselves do not participate again in the combustion process in the combustion chamber of the internal combustion engine so that they constitute an inert gas that dilutes the mixture of combustion air and fuel in the combustion chamber and ensures more intimate mixing. It is thus possible to minimize the occurrence of what are termed “hot spots” during the combustion process, said hot spots being characterized by very high local combustion temperatures. Such very high combustion temperatures promote the formation of nitrogen oxides and must therefore be avoided.

Since the efficiency of an internal combustion engine is typically dependent on the temperature of the combustion air fed into the combustion chamber of the internal combustion engine, the combustion gases cannot be recirculated to the intake side immediately after having left the combustion chamber of the internal combustion engine. Instead, the temperature of the combustion gas must be significantly lowered. Typically, the temperatures of the combustion gases leaving the combustion chamber of the internal combustion engine are 900° C. and more. The temperature of the combustion air fed to the combustion chamber of the internal combustion engine on the inlet side should, by contrast, not exceed 150° C. and preferably be significantly less than that. For cooling the recirculated combustion gases, it is known in the art to utilize what are termed exhaust recirculation coolers. Various constructions are known in the art in which the combustion gases to be cooled are usually circulated through exchanger tubes around the outer side of which a coolant flows, the coolant usually being the cooling water of the motor vehicle. For efficiency increase, it has been proposed in prior art to lead the combustion gases to be cooled through a bundle of exchanger tubes connected in parallel in terms of fluid flow, the coolant generally flowing around said tubes.

From the document DE 10 2004 019 554 A1 an exhaust gas recirculation system for an internal combustion engine is known which comprises an exhaust gas heat exchanger implemented as a two-part cast part. Since the very hot combustion gases are reactive due to the fact that the fuel never burns completely, the problem here is that it is technically difficult if not impossible to design the surfaces of a metallic cast part as inert surfaces comparable with a stainless steel surface.

From the document DE 10 2005 055 482 A1, an exhaust gas heat exchanger for an internal combustion engine is known that avoids the problems mentioned above by implementing the surfaces coming into touching contact with the hot combustion gases as non-corrosive steel surfaces. The heat exchanger tubes and the housing accommodating the heat exchanger tubes are configured to be separate parts that are assembled during the manufacturing process.

In the exhaust gas heat exchanger known from the document DE 10 2006 009 948 A1, the channels carrying the hot gas and the housing in which the coolant flowing around the exhaust channels flows are configured integrally in the form of a plate heat exchanger. The flow paths for the hot combustion gases as well as the flow paths for the coolant only form when individual plates, for example deep-drawn plates, are being assembled to form a plate heat exchanger. A similar concept is pursued in the document DE 10 2006 049 106 A1.

General information regarding the technique of exhaust gas recirculation in internal combustion engines may be inferred from the document DE 100 119 54 A1 for example.

It would be desirable to produce a heat exchanger for an exhaust train of a motor vehicle that offers advantages in weight and manufacturing costs over the prior art constructions.

### SUMMARY OF THE INVENTION

Consistent and consonant with the present invention, a heat exchanger for an exhaust train of a motor vehicle that offers advantages in weight and manufacturing costs over the prior art constructions, has surprisingly been discovered.

A heat exchanger of the invention is provided for use in the exhaust train of a motor vehicle, here in particular for cooling the outlet side combustion exhaust gases recirculated to the inlet side of the combustion chambers of the internal combustion engine. The heat exchanger comprises at least one separately configured exhaust gas carrying exchanger tube that is disposed in a separately configured, closed housing. A coolant flows through this housing; the coolant may be the coolant from the coolant circuit of the internal combustion engine of the motor vehicle, for example. The coolant flowing through the housing flows around the outer side of the at least one exchanger tube, thereby absorbing the combustion heat carried by the recirculated combustion exhaust and dissipating it through the coolant circuit of the motor vehicle.

In accordance with the invention, the housing of the heat exchanger is divided into at least two housing portions, namely a housing cover and a housing case. The housing case is tightly closed by the housing cover. In accordance with the invention, both ends of the at least one exchanger tube are led through a common housing portion of the heat exchanger housing so as to be gas and liquid tight, the housing portion being referred to as a cover part within the frame of the present invention. Usually, the housing portion referred to as the housing case then encloses the exchanger tube mechanically fixed to the cover part, thus forming the housing of the heat exchanger. Alternatively, it is also possible that the cover part itself virtually completely encloses the exchanger tube it carries mechanically and that the housing of the heat exchanger of the invention is closed by placing thereon a second housing portion referred to as the housing case, even if the housing portion referred to as the “housing case” does not practically enclose the exchanger tube in this embodiment. It is understood that combinations of housing cover and housing cases are also possible in which both the housing cover and the housing case partially enclose the at least one exchanger tube.

By implementing the exchanger tube and the housing of the heat exchanger of the invention separately, these elementary component parts of the heat exchanger of the invention can be formed from different materials. By dividing the housing into two housing portions, both ends of the at least one heat exchanger tube being led through only one housing portion, the material of this housing portion can be adapted on purpose to the thermal, mechanical and/or corrosion requirements for the purpose of utilization. Particular advantages are obtained if the at least one exchanger tube is made from a non-corrosive and heat resistant material such as stainless steel or aluminium. The use of stainless steel further offers the advantage that an exchanger tube made from stainless steel has increased flexibility, which brings a substantial advantage when realizing a winding flow path in the exchanger tube. If the demands placed on corrosion resistance or on heat resistance are less high, it may be sufficient to make the at least one exchanger tube from aluminium or from an aluminium alloy.

The housing cover is advantageously formed from the same material as the at least one exchanger tube since it is thus ensured that the two parts may be readily connected together mechanically and that they are less prone to corrosion. If both parts, meaning housing cover and exchanger tube, are made from stainless steel, excellent corrosion resistance as well as very high heat load capacity are generally ensured. Moreover, the lower heat conductivity of stainless steel minimizes the transmission of lost heat of the very hot combustion exhaust through the housing cover to the housing case. With certain reservations, the use of aluminium or of an aluminium alloy or of other metallic materials exhibiting appropriate thermal resistance is also suited here insofar as this material may be suitably connected in a gas and liquid tight manner to the exchanger tube extending therethrough, such as by welding, soldering or at need also by gluing.

The case of the housing of the exhaust gas heat exchanger of the invention may of course also be made from stainless steel, such as from a seamless drawn stainless steel tube with inserted bottom part. The partitioning of the heat exchanger housing makes it possible to form the housing case as a cast part, which brings particular advantages. The housing case may for example be manufactured from a castable material such as aluminium, an aluminium alloy, magnesium or a magnesium alloy, gray cast iron or from a plastic material having sufficient temperature resistance. Since the housing case of the exhaust gas heat exchanger of the invention does not come into touching contact with the corrosive combustion exhaust and since the temperatures are limited to typical coolant temperatures of less than 150 degrees C., the materials mentioned herein above, which are much cheaper, may be used instead. More specifically, the housing case can be made by casting, for example by means of plastic or metal die casting or by means of other low-cost methods such as deep-drawing for example. Beside the already mentioned advantages in terms of costs and the more easy manufacturability of a cast or drawn housing case, cast housing parts may further significantly reduce the weight over stainless steel housings, which constitutes another advantage of the exhaust gas heat exchanger of the invention. An unwanted side effect of the increasing complexity of motor vehicles is that their weight increases steadily, this going against the efforts of the motor vehicle manufacturers to minimize the consumption and emission rates of the motor vehicles.

Particular advantages are obtained if a seal is inserted between the housing case and the housing cover. The seal may be in particular made from a metallic material such as a metal bead seal or an elastic seal (e.g., an elastomer seal). In this context, it is particularly advantageous if the housing cover and the housing case are configured to be separate parts that are joined together by means of mechanical retaining means. Screws or rivets may be used as such retaining means, for example. It is understood that any other mechanical retaining means may be envisaged as far as they are known in the art and suited for connecting at least once the housing cover and the housing case. In this context, a connection with no auxiliary means such as beading may also be of advantage.

In a particularly preferred developed implementation of the heat exchanger of the invention, the housing cover thereof forms an interface for connecting the heat exchanger to the exhaust system of the motor vehicle. In this way, the mounting of the heat exchanger of the invention in the motor vehicle is considerably simplified.

The exchanger tube of the heat exchanger of the invention is preferably made from one piece, at least between the points at which it extends through the housing cover of the heat exchanger. In particular, it may thereby be curved into a U-shape or into a semi-circular shape. In this way, corrosion may be prevented at the transitions between tube portions. Furthermore, this preferred implementation only has one single fluid mechanical constriction for the flow passing through the exhaust gas heat exchanger so that the pressure drop in the exhaust gas flowing through the heat exchanger is minimized.

In a particularly preferred implementation, the flow path extending in the exchanger tube runs at least inside the housing of the heat exchanger in the form of a winding flow path. More specifically, this flow path may have an included angle of rotation α of at least 45° inside the housing, preferably however, an angle of rotation α ranging between 135 and 225°. Particularly preferred is an angle of 180°, i.e., the cooled combustion exhaust exiting the heat exchanger of the invention leaves the heat exchanger in the direction opposite the direction of entrance.

By virtue of the curved implementation of the flow path of the combustion exhaust to be cooled, the space is significantly improved over exhaust gas heat exchangers known in prior art typically having rectilinear exchanger tubes. The separate configuration of housing and exchanger tubes of the heat exchanger of the invention allows for a particularly simple production of same and makes it furthermore possible to utilize for the heat exchanger of the invention materials adapted to the respective locally prevailing requirements with respect to corrosion and heat resistance.

In a preferred developed implementation, rather than one single exchanger tube, a bundle of exchanger tubes is provided in the heat exchanger of the invention, which are connected in parallel in terms of fluid flow. More specifically, this bundle of exchanger tubes is to be configured such that the flow paths forming in the discrete exchanger tubes have no contact with the flow paths in the adjacent exchanger tubes between their respective inlets and outlets. In this way, it is avoided that the exhaust flow to be cooled has to pass several times through cross section constrictions when passing through the exhaust gas heat exchanger of the invention. As a result, the flow resistance of the heat exchanger of the invention is clearly reduced on the one side, on the other side it has been found out in practical operation that each constriction in the flow path inside an exhaust gas heat exchanger forms a location at which condensate and particles contained in the recirculated combustion exhaust deposit, this possibly leading in the long run to a partial or complete clogging of the heat exchanger and, as a result thereof, to a failure of the entire exhaust gas recirculation system of the motor vehicle.

If a bundle of exchanger tubes are being used, and in particular when water is used as a coolant, a minimum distance d between the outer surfaces of the neighboring exchanger tubes ranging between 0.5 mm and 5 mm has provided favorable results. Particularly favorable results have been obtained with a gap width of between 1 and 2 mm. In particular with regard to water as a coolant, this gap width is best on the one side with respect to the flow resistance for the coolant and on the other side with respect to optimizing the flooded surface of the exchanger tubes in relation with the volume through which the coolant flows.

If a bundle of exchanger tubes is utilized, it has been found out best, with respect to space occupancy, if both the center points of the inlets and the center points of the outlets of the exchanger tubes or alternatively the supporting points, i.e., those points at which the exchanger tubes pass through the wall of the heat exchanger housing, rest on the center points of an orthogonal or hexagonal grid. Preferably, both the inlets and the outlets or the supporting points are disposed on grid points of equivalent grids. Alternatively, or also in complement, the passage points at which the discrete exchanger tubes pass through the wall of the housing of the heat exchanger on the inlet side and on the outlet side could also be disposed on grid points of comparable grids. Such an arrangement of the inlets or outlets of the exchanger tubes or of their passage points through the wall of the exchanger housing allow in turn for a particularly efficient use of the space available inside the exchanger housing. In particular if the heat exchanger tubes are arranged in a hexagonal pattern, the space inside the heat exchanger housing with the exchanger tubes is particularly intensively filled so that the space is here efficiently minimized.

In particular if the exchanger tubes have a U-shaped configuration, the space occupancy inside the housing of the heat exchanger can be further optimized if the exchanger tubes are disposed so as to intersect each other at least by pairs.

The at least one exchanger tube, but also the majority of the exchanger tubes of a bundle in an embodiment, can be configured to be a smooth-walled tube in an implementation of a simple design. Advantages with respect to thermal efficiency of the heat exchanger of the invention are obtained though, if the at least one exchanger tube, or also the majority of the exchanger tubes, is configured to be a swirl tube, i.e., a tube that is designed so that the hot exhaust gas flow carried inside thereof experiences an intensive turbulence. For this purpose, at least the inner surface of the exchanger tube/of the exchanger tubes may be equipped with a spiral structure imparting a swirl movement to the exhaust gas flow flowing therethrough.

Such a spiral structure may in particular also be achieved by making a spiral-shaped depressed structure in the wall of an otherwise smooth-walled tube made e.g., from stainless steel. A spiral structure on the inner wall of the exchanger tube can be readily produced by widening or deepening in a spiral shape a preferably thin-walled exchanger tube that can for example be made from stainless steel. In the given case of application and with water as the coolant, the winding distance DS of such a spiral structure advantageously ranges between 1 and 15 mm, preferably between 3 and 8 mm. The height or depth of the spiral structure in turn ranges between 1 and 20% of the outer diameter D of the exchanger tube, preferably however between 2 and 16%, in the given case of application. The outer diameter D of the exchanger tube ranges, again related to the special case of application, preferably between 1 and 15 mm, with the range between 6 and 12 mm having been found out to be particularly advantageous. For the preferred range, the ratio between occurring pressure loss or flow resistance for the recirculated combustion exhaust gas on the one side and thermal efficiency of the exhaust gas heat exchanger of the invention by virtue of the ratio tube cross section to inner surface of the heat exchanger tubes on the other side has proved best.

A particularly efficient space occupancy inside the housing of the heat exchanger is obtained if the exchanger tube is curved, substantially in a U-shape or in a semi-circular shape, between the points at which it is fed through the wall of the housing. In combination with the configuration of the exchanger tube as a swirl tube, one thus obtains a particularly intensive turbulence of the hot exhaust gas flow flowing through the exchanger tube, which leads to a particularly effective heat transfer onto the wall of the exchanger tube and, as a result thereof, to a transfer to the coolant.

As already mentioned above, in an embodiment, the at least one exchanger tube, preferably however the majority of the exchanger tubes provided, are mechanically solidly connected to the housing cover where the respective tubes pass through said cover. In this way, the at least one exchanger tube/the majority of the exchanger tubes abuts mechanically on the housing cover and forms a simple-to-handle mounting unit that can be mechanically connected in a most simple way to the case of the exchanger housing during final assembling of the heat exchanger of the invention.

Further advantages are obtained if the passage points, i.e., those points at which the at least one exchanger tube is conducted through the housing of the heat exchanger on the inlet side and on the outlet side, are substantially disposed in a common plane E. The inlet and the outlet of the exchanger tube may also be disposed substantially in a common plane E′ that may more particularly coincide with the previously mentioned common plane E′ of the passage points. One of the planes E or E′ can form an interface for a connection of a heat exchanger to the exhaust gas system of the motor vehicle so that the heat exchanger of the invention may be mounted particularly easily to the coolant circuit or exhaust gas system of the motor vehicle.

These advantages can be further enhanced by arranging the coolant inlet and the coolant outlet for the coolant flowing through the housing of the heat exchanger of the invention also in the plane E of the passage points of the exchanger tube or in the plane E′ of the inlet and the outlet of the exchanger tube. In a particularly preferred implementation, the planes E and E′ coincide so that both the passage points and inlet and outlet of the exchanger tube as well as coolant inlet and coolant outlet are substantially disposed in one plane. This common plane can then advantageously form an interface for a connection of the heat exchanger to both the exhaust gas system of the motor vehicle and the coolant system of the motor vehicle. Preferably, at least the coolant inlet and/or the coolant outlet are formed in the housing cover of the heat exchanger housing. In this way, the mounting interface can be formed in the simplest way on the heat exchanger.

Further advantages are obtained if the exchanger tubes of the heat exchanger of the invention are substantially made from one piece between their inlet and their outlet, at least if they are made from one piece between the previously mentioned passage points. In particular, the at least one exchanger tube can be substantially curved into a semi-circular shape or into a U-shape between its inlet and its outlet or between its passage points through the wall of the housing.

Finally, it is noted that the medium of the heat exchanger of the invention may be exchanged, i.e., cooling medium can also flow through the exchanger tube and the flow of medium to be cooled, meaning e.g., the exhaust gas flow to be cooled, can also flow through the housing inner volume surrounding the exchanger tube.

A heat exchanger of the invention is further suited for use as a charge air cooler in a motor vehicle with an internal combustion engine in which the combustion air is compressed to a pressure above atmosphere pressure through a compressor connected upstream thereof such as a turbocharger or a compressor. It is particularly suited for use as a charge air cooler in connection with a low-pressure exhaust gas recirculating system.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawing which:

FIG. 1 shows an exploded view of a first exemplary embodiment of an exhaust gas heat exchanger of the invention;

FIG. 2 is an elevation view of the mounting interface E of an exhaust gas heat exchanger according to a second exemplary embodiment;

FIG. 3 is an elevation view of a bundle of exchanger tubes of an exhaust gas heat exchanger according to a third exemplary embodiment;

FIG. 4 is a schematic illustration of an exchanger tube of the heat exchanger shown in FIG. 1;

FIG. 5 is a sectional view through the exchanger tube shown in FIG. 4;

FIG. 6 is a schematic view of an exchanger tube that forms a winding flow path for illustrating the revolution angle α;

FIG. 7 is an elevation view of the interface E formed by one housing cover in which the inlet and outlet openings are disposed on grid places of an orthogonal grid;

FIG. 8 is an elevation view of the interface E formed by one housing cover in which the inlet and outlet openings are disposed on grid places of a hexagonal grid;

FIG. 9 is a sectional view through an inlet/outlet opening of an exchanger tube in the region of a housing cover; and

FIGS. 10a-10g show swirl tubes that are suited for use in a heat exchanger of the invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

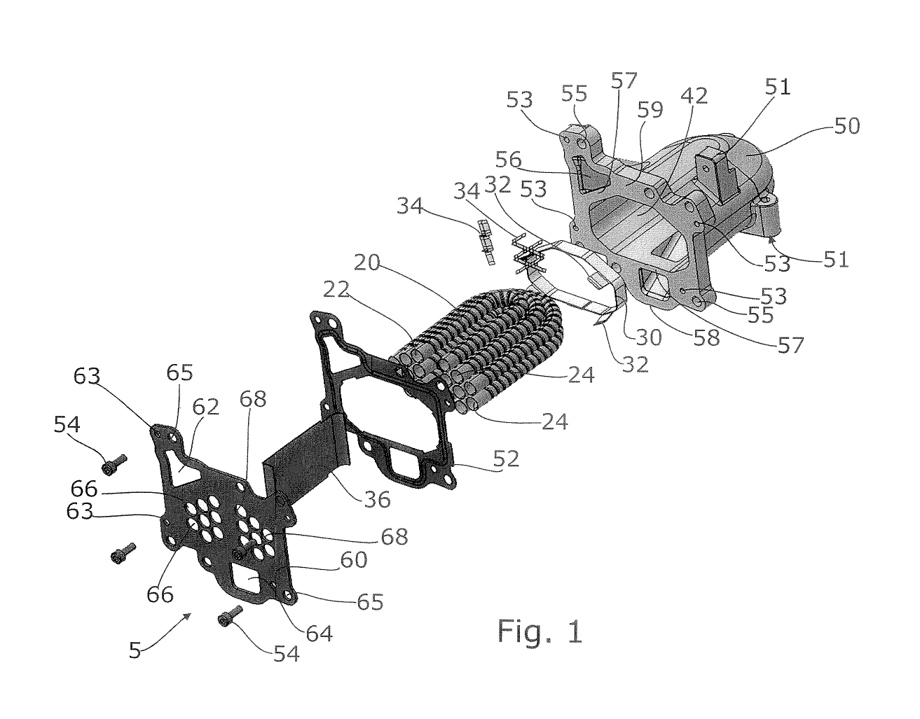

FIG. 1 shows an exploded view of an exhaust gas heat exchanger 1 according to a first exemplary embodiment. The heat exchanger 1 includes housing 40 that consists of a housing case 50 which is closed by means of a housing cover 60. The housing case 50 is configured to be a cast part and may be made from aluminium die casting in particular. Alternatively, the housing case 50 in the exemplary embodiment shown may be made from any material that can be processed by casting on the one side and that has sufficient thermal stability on the other side. Since the housing case 50 of the heat exchanger 1 of the invention only comes into touching contact with the coolant usually originating from the coolant circuit of the motor vehicle, a resistance to temperatures of up to 150° C. is sufficient for most of the cases of application. Magnesium or magnesium alloys, gray cast iron or also heat resistant and die-castable plastic materials have been found to be further materials suited for the housing case.

On the front side, the housing case 50 forms a flange 59 for connection to a housing cover 60. In the exemplary embodiment shown, the housing cover 60 consists of a punched steel plate having a thickness of a few millimeters, preferably of approximately 1-2 mm. The housing case 50 is connected for liquid and gas tight connection to the housing part 60, a seal 52, which, in the exemplary embodiment shown, is configured to be a metal bead seal, being inserted therein between. The housing cover 60 is thereby screwed to the flange 59 of the housing case 50 by means of screws 54. For this purpose, the housing case 50 forms a plurality of large threaded holes 55. At the corresponding positions, the housing cover 60 comprises through holes 65 of large diameter through which screws 54 of mating dimensions are threaded and inserted into the threaded holes 55 for the housing cover 60 to be screwed to the housing case 50.

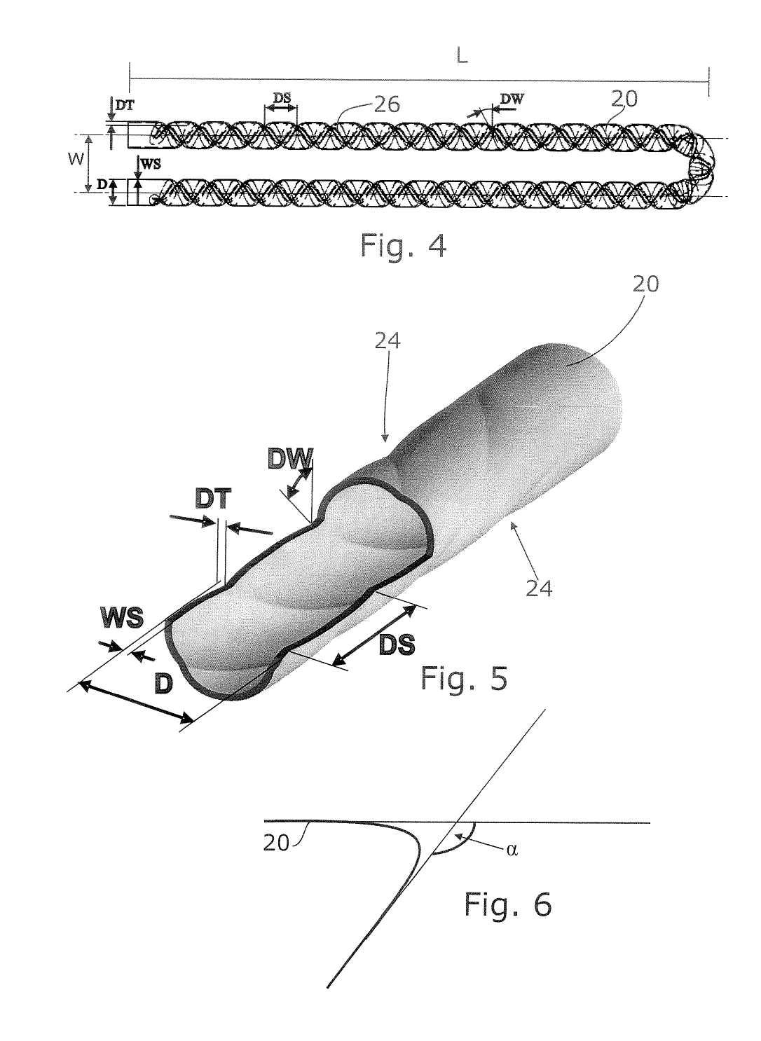

The housing case 50 forms an inner volume 42 that is provided for accommodating therein a bundle of U-shaped exchanger tubes 20. The exchanger tubes 20 are identical with respect to their dimensions such as inner and outer diameter, but the opening width W (see FIG. 4) of the U-shaped profile varies. The shape of the inner volume 42 and as a result thereof of the housing case 50 is generally adapted to the shape of the bundle of exchanger tubes 20 so that the bundle of exchanger tubes allows for using most efficiently the space in the inner volume 42.

At their respective ends, the exchanger tubes 20 each form an inlet 22 and an outlet 24. The ends of the exchanger tubes 20 are thereby conducted through corresponding holes in the housing cover 60, which form the passage points 66, 68 for the inlets 22 or the outlets 24 of the exchanger tubes 20. The inlets and outlets 22, 24 of the exchanger tubes 20 are thereby conducted through the holes formed in the housing cover 60. At the passage points 66, 68, the exchanger tubes 20 are connected for gas and liquid tight connection to the housing cover 60 such as by soldering or welding. As a result, the exchanger tubes 20 mechanically abut the housing cover 60.

In an embodiment, the exchanger tubes 20 consist of thin-walled stainless steel tubes. The exchanger tubes 20 are thereby provided with a stamped structure so that a raised spiral-shaped structure 26 is formed on the inner surface of the exchanger tubes 20. The bundle of exchanger tubes 20 is thereby disposed so that all the inlets 22 and all the outlets 24 are respectively arranged in one cohesive group for ease of connection of the heat exchanger 1 of the invention to the exhaust gas system of the motor vehicle for example. For this purpose, the front side of the housing cover 60 forms an assembly interface S that is configured in a substantially flange-like fashion due to the planar configuration of the housing cover 60. For mounting the heat exchanger 1 to the motor vehicle, further threaded holes 53 are formed in the housing case 50, said holes having a smaller diameter compared to the threaded holes 55. In the metal bead seal 52 as well as in the housing cover 60 there are formed corresponding through holes 63. Via these holes, the heat exchanger 1 can be connected to the exhaust gas and coolant system of the motor vehicle through a plurality of screws, which have not been illustrated in FIG. 1.

Beside the inner volume 42 accommodating the bundle of exchanger tubes 20, the housing case 50 forms an inlet channel 56 and an outlet channel 58 for a coolant; said coolant can be a cooling liquid from the cooling system of the internal combustion engine of the motor vehicle. The inlet channel 56 and the outlet channel 58 are thereby arranged for a flow path extending from the top to the bottom (in FIG. 1) to form through the inner volume 42 of the housing case 50 when the heat exchanger 1 is operated according to the use it was intended for so that the bundle of exchanger tubes 20 is intensively flooded by the coolant. In order to achieve as intensive as possible an interaction between the coolant and the surface of the exhaust gas carrying exchanger tubes 20, a baffle plate 36 is disposed within the legs of the U-shaped exchanger tubes 20, said baffle plate being again preferably made from stainless steel in the exemplary embodiment shown and being butt soldered or butt welded to the housing cover 60 also made from stainless steel. The baffle plate 36 lengthens the flow path of the coolant in the inner volume 42 of the housing 40, thus ensuring a more intensive thermal exchange between the exhaust gas flowing in the exchanger tubes 20 and the coolant flowing in the inner volume 42.

The inlet channel 56 as well as the outlet channel 58 formed in the housing case 50 also end in the flange 59 formed by the housing case 50, webs 57 being formed at the ends of the channels 56 and 58 for forming a mechanical abutment for the metal bead seal 52 resting on the flange 59. Said seal also forms passageways for the coolant flowing through the heat exchanger 1, which correspond to the coolant inlet 62 and the coolant outlet 64 formed in the housing cover 60. In the assembled heat exchanger 1, coolant can be both supplied through the coolant inlet 62 and evacuated through the coolant outlet 64 and the combustion exhaust gas to be cooled can be supplied through the inlets 22 of the exchanger tubes 20 and evacuated through the outlets 24 via the front side of the housing cover 60. In the construction shown, this is possible through one single common mounting interface S.

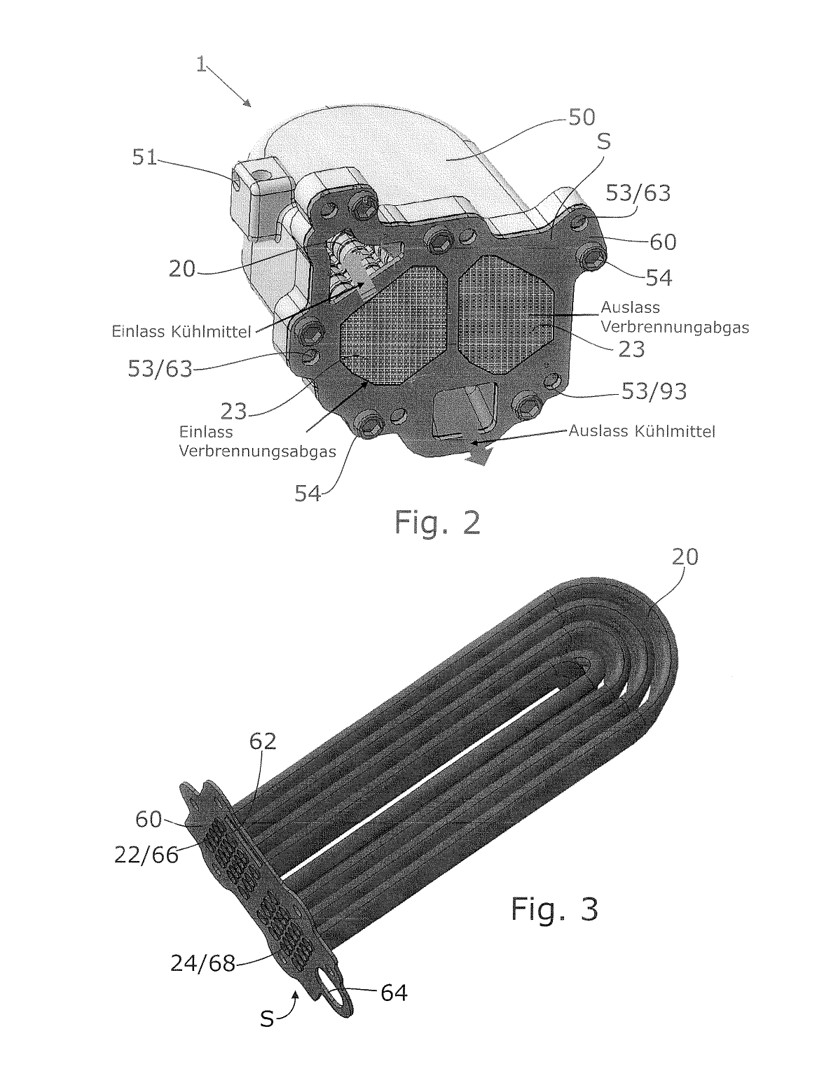

This is particularly obvious from the illustration shown in FIG. 2 which shows an elevation view of a mounting interface S of the heat exchanger 1 in a slightly altered embodiment. The coolant inlet 62 formed in the housing cover 60 and the coolant outlet 64 are clearly visible. By contrast, the majority of inlets 22 and outlets 24 of the exchanger tubes 20 are covered by grid structures 23 in the illustration shown in FIG. 2. The arrangement of the inlets 22 and of the outlets 24 in the housing cover 60 substantially corresponds to the configuration shown in FIG. 1. For the rest, the heat exchanger shown in the illustration of FIG. 2 substantially differs by the modified arrangement of fastening points 51 to the housing case 50, these fastening points 51 serving to fasten the heat exchanger 1 to mounting structures of the motor vehicle.

FIG. 3 shows a perspective illustration of a bundle of exchanger tubes 20 of a heat exchanger 1 in a third implementation. As compared to the heat exchanger 1 shown in FIG. 1, the bundle of exchanger tubes 20 shown herein substantially differs by the fact that the exchanger tubes 20 are smooth, e.g., seamless drawn thin-walled stainless steel tubes that have no spiral-shaped structure 26 like the one shown in FIG. 1. Furthermore, the exchanger tubes 20 are arranged so as to intersect by pairs, this being visible at the inversion points of the U-shaped exchanger tubes 20 in FIG. 3.

In FIG. 1 it can be further seen how undesirable oscillations of the bundle of exchanger tubes 20 in the inner volume 42 of the housing 40 can be prevented by means of technical measures. The baffle plate 36, which is connected for mechanical rigid connection to the housing cover 60 and is disposed within the bundle of exchanger tubes 20, is connected at its side wall and at its bent tip to the neighboring exchanger tubes 20 such as by soldering or welding for a mechanical solid connection. The baffle plate 36 thus mechanically stiffens the exchanger tubes 20 of the exchanger tube bundle lying inside, thus attenuating their oscillations.

As an additional measure to reduce the oscillations there is provided a bandage 30 made from a stamped stainless steel sheet of small wall thickness. This bandage completely surrounds the bundle of the exchanger tubes 20 and is connected at the contact points to the neighboring exchanger tubes 20 for mechanical solid connection such as by means of welding or soldering. Thanks to the arrangement surrounding the bundle of exchanger tubes, the bandage 30 prevents relative oscillations of the outside lying exchanger tubes 20 relative to each other. Moreover, the bandage 30 forms integrally formed abutments 32 that consist of angled projections. These abutments 32 resiliently support the entire bundle of exchanger tubes with respect to the inner wall of the housing 40.

Finally, stiffening elements 34 are arranged within the bundle of exchanger tubes 20, which also are made from stamped stainless steel strips. These stiffening elements 34 constitute a mechanically rigid abutment of the exchanger tubes 20 of the bundle of exchanger tubes. For this purpose, they are connected to the exchanger tubes 20 for mechanical solid connection such as by means of welding or soldering.

It is noted that the mechanical solid connection of the bandage 30 or of the stiffening elements 34 to the discrete exchanger tubes 20 can be eliminated. Possibly, the mere interlock between the bundle of exchanger tubes and the bandage 30 or the stiffening element 34 may already provide for sufficient abutment of the bundle of exchanger tubes and for the bandage 30 or the stiffening elements 34 to sit sufficiently solidly on the bundle of exchanger tubes.

FIG. 4 now shows an elevation view of one exchanger tube 20 of the heat exchanger 1 according to the first exemplary embodiment. The exchanger tube 20 has a free length indicated at L that can range between 2 and 30 cm depending on the dimensions of the heat exchanger 1; if used in motor vehicles with an internal combustion engine of less output (typically 35-100 kW), appropriate typical dimensions of L are of about 5 cm. For private cars of higher output of 100 kW and more, dimensions of L ranging between 10 and 15 cm may be sensible. For use in trucks, dimensions of L=20 cm and more may be suited.

The exchanger tube 20 has an outer diameter D that typically ranges between 1 and 15 mm, preferably between 6 and 12 mm, since this diameter has been found particularly suited for using the heat exchanger in accordance with its purpose of utilization as an exhaust gas heat exchanger for a motor vehicle. As can be seen in FIG. 4 and in FIG. 5, which constitutes a perspective sectional view of the exchanger tube 20 of FIG. 4, values ranging from 0.1 to 1 mm are suited for the wall thickness WS of the exchanger tubes 20, depending in particular also on the length L of the exchanger tube 20 in the specific heat exchanger 1. Preferably, the wall thickness WS of the exchanger tubes 20 ranges from 0.2 through 0.6 mm.

For the spacing W between the legs of the U-shaped exchanger tubes 20, it has been found out that this spacing is preferably greater than or equal to 1.8 times the outer diameter D of the exchanger tube 20. The following applies in particular. W is greater than or equal to 1.8×D, and it has been found out that the leg width W, which is directly correlated to the bending radius R of the U-shaped exchanger tube 20, is greater than W=2R, if the exchanger tube 20 used is a thin-walled tube, for example made from stainless steel or aluminium, provided with a continuous spiral structure 26. A particularly small leg width W is of benefit for most efficient possible occupancy of the inner volume of the housing 40 and is to be preferred due to the very limited space available in a motor vehicle.

Within the frame of practical testing it has been found out that particularly advantageous properties with respect to generating a turbulence in the exhaust gas flowing through the exchanger tube 20 and as a result thereof a particularly intensive heat transfer from the exhaust gas to the wall of the exchanger tube are achieved if the exchanger tube 20 comprises a spiral structure 26 at least on its inner wall. The spacing DS between the windings of the spiral structure 26 advantageously ranges between 1 and 15 mm, with a range of between 4 and 8 mm being preferred. The resulting pitch is indicated at DW in FIG. 4. The height DT of the raised spiral structure 26 on the inner wall of the exchanger tube 20 advantageously ranges between 1 and 20% of the outer diameter D of the respective exchanger tube 20, with a range of between 2.0 and 14% being preferred here.

If a plurality of exchanger tubes 20 is provided for a bundle of exchanger tubes to form, it has been found out that the efficiency achievable if the heat exchanger is used according to its purpose of utilization is particularly high if the minimum distance d between the outer surfaces of the respective exchanger tubes 20 of the bundle of exchanger tubes ranges between 0.5 and 5 mm. A range of between 1 and 2 mm is preferred here, since it yields particularly good results with respect to efficiency if water is used as the coolant.

In an embodiment of the invention, the spiral structure 26 in the exchanger tube 20 is not only formed on the inner surface of the exchanger tube 20. Instead, the spiral structure 26 is produced by stamping a spiral shape into the outer surface of the exchanger tube 20, which results in a stamped raised spiral structure 26 on the inner surface of the exchanger tube 20.

FIG. 6 schematically shows the angle of rotation α that is surrounded by the flow path forming in the exchanger tube 20. In the preferred embodiments of the heat exchanger 1 of the invention, this angle of rotation α=180°, i.e., the flow direction of the exhaust gas flow exiting the inner volume 42 of the heat exchanger 1, is 180° opposite the flow direction of the entering exhaust gas flow. In other configurations, the angle of rotation α may however be smaller or greater than 180°, an angular range of between 135° and 225° being generally preferred. The use of exchanger tubes 20 forming a spiral structure 26 on their inner surface has already been found to increase efficiency at an angle of rotation α of 45°.

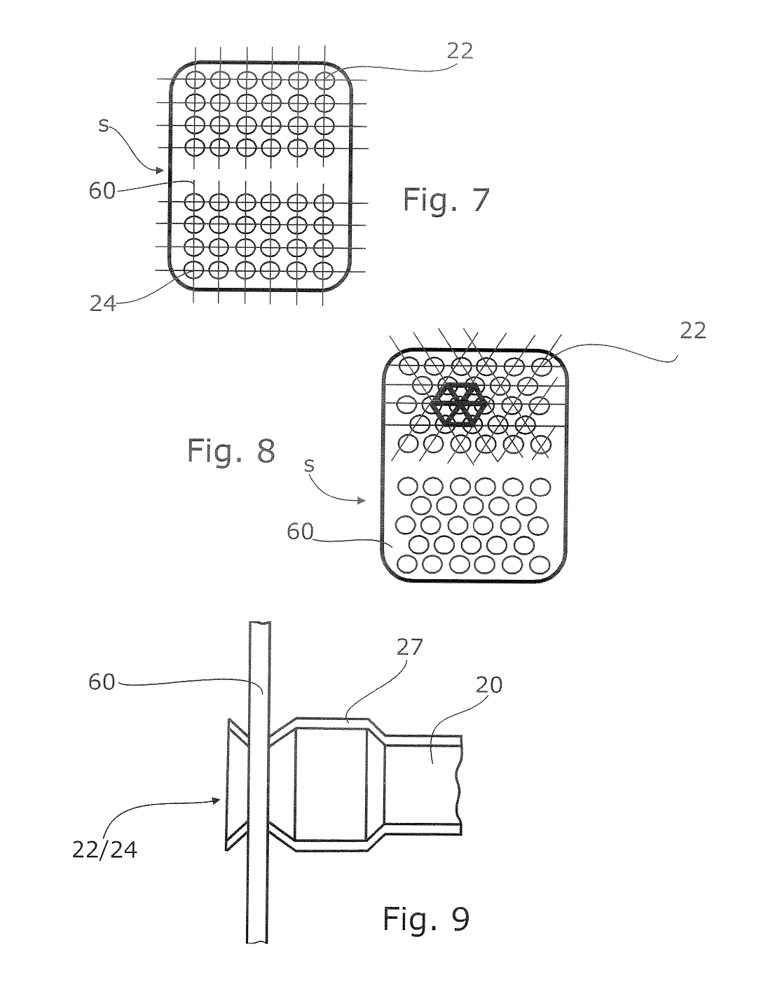

FIG. 7 schematically shows once more an elevation view of the inlets 22 and the outlets 24 of a plurality of exchanger tubes 20 that are arranged in a bundle in the inner volume 42 of a heat exchanger housing 40. It appears that both the inlets 22 and the outlets 24 are disposed on the grid points of an orthogonal grid.

An even more efficient space occupancy is obtained if the inlets 22 and outlets 24 are arranged as shown in FIG. 8. Here, the inlets 22 or outlets 24 are disposed on grid points of a hexagonal grid, which means that each inlet 22 or each outlet 24 is surrounded by six neighboring inlets 22 or outlets 24. In this configuration, the space inside the inner volume 42 of the housing 40 can be best used for the exchanger tubes 20.

FIG. 9 shows a sectional view of a housing cover 60 in the region of a hole through which the inlet or outlet side end 22/24 of an exchanger tube 20 is threaded. In a preferred implementation, which offers particular advantages for manufacturing, the exchanger tube 20 comprises at its inlet or outlet side end 22/24 a supporting structure 27 that forms a mechanical abutment of the tube end with respect to the housing cover 60. This supporting structure may for example be formed from one or several dot-shaped projections, in the exemplary embodiment shown in FIG. 4 it is stamped as a circumferential bulge. In the exemplary embodiment shown in FIG. 9, the outer end of the exchanger tube 20 is beaded so that, generally, the exchanger tube 20 mechanically abuts the housing cover 60 through the combination of supporting structure 27 and beaded end. This abutment substantially facilitates the manufacturing of the heat exchanger of the invention since the exchanger tubes 20 are already pre-fixed mechanically in the housing cover 60. This dispenses with the need for additionally fixing the exchanger tubes 20 to the housing cover 60 such as by means of laser welding spots during subsequent soldering or welding of the exchanger tube ends to the housing cover 60. The structures shown in FIG. 9 may be made in the simplest way in the exchanger tube end by threading an exchanger tube 20 with uniform inner and outer diameter through the corresponding hole in the housing cover 60. After that, the circumferential bulge 27 and at the same time the beaded edge is produced using an appropriate tool. This appropriate tool is for example a tube expansion tool.

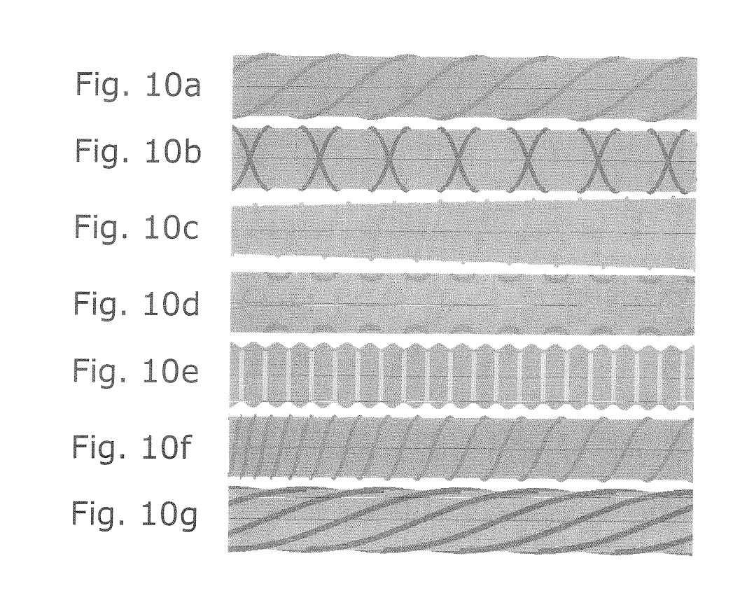

The sequence of the FIGS. 10 a through g finally shows by way of example a selection of swirl tubes the structure of the inner surface of which is suited for creating a turbulence in the exhaust gas flow flowing inside, in particular, if the flow path forming the at least one exchanger tube 20 of the heat exchanger 1 made from the swirl tube has an included angle α of more than 45°, in particular of 180°. FIG. 10 a shows once more the spiral structure shown in FIG. 5, which has a constant pitch and a constant structure height DT and is formed in a tube 20 having a constant cross section over its length.

FIG. 10 b shows a swirl tube having two substantially identical spiral structures, wound however in opposite directions. Except for a reduced pitch, each of the two spiral structures corresponds to the spiral structure shown in FIG. 5. Also, the cross section of the tube is substantially constant over its entire length.

FIG. 10 c shows a swirl tube in which the cross section of the tube tapers/widens over its length. The spiral structure itself again substantially corresponds to the structure shown in FIG. 5.

By contrast, in the swirl tube shown in FIG. 10 f, the cross section of the tube is again substantially constant over its entire length whilst the pitch of the spiral structure varies over the length of the tube.

FIG. 10 d shows an alternative to the spiral structures of the other structure examples, namely planar circular depressions in the wall of the tube, which result in circular raised structures on the inner wall of the tube. Instead of planar circular depressions, annular depressions may also be formed in the wall.

The turbulence structure shown in FIG. 10 e is not spiral-shaped either; instead, the tube wall is annularly deformed at even intervals, thus resulting in regular constrictions on the inner wall. Over the length of the tube, the depth of the constrictions and/or their spacing may be varied.

FIG. 10 g finally shows a swirl tube with a substantially constant cross section in the wall of which there is formed a plurality of identical spiral structures having a constant pitch and structure height.

To conclude, it is noted that the turbulence structures shown in the FIGS. 10 a through g can not only be utilized isolated, but may be freely combined together if technically practicable. The structure features of the FIGS. 10 a through c as well as f and g in particular can be advantageously combined together.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A heat exchanger for an exhaust gas system of a motor vehicle comprising:
a closed housing including at least one housing cover and one housing case, wherein the housing case is enclosed by the housing cover; and
an exhaust gas carrying exchanger tube disposed in the housing, an outer surface of the exchanger tube forming a substantially fluid tight seal with the housing and a first end and a second end of the exchanger tube are disposed outside of the housing, wherein a coolant flows through the housing and around an outer surface of the exchanger tube.

2. The heat exchanger as set forth in claim 1, wherein the exchanger tube is made from a corrosion and heat resistant, substantially flexible material.

3. The heat exchanger as set forth in claim 1, wherein the housing cover is produced from a material of the same material as the exchanger tube.

4. The heat exchanger as set forth in claim 1, wherein the housing case is produced from one of a castable material and a material that is deep-drawn.

5. The heat exchanger as set forth in claim 1, wherein the housing case is formed as a cast part.

6. The heat exchanger as set forth in claim 1, wherein a seal is disposed between the housing case and the housing cover.

7. The heat exchanger as set forth in claim 6, wherein the seal is produced from an elastic material.

8. The heat exchanger as set forth in claim 1, wherein the housing cover and the housing case are separate parts joined together by means of mechanical retaining means.

9. The heat exchanger as set forth in claim 1, wherein the housing cover forms an interface for connecting the heat exchanger to the exhaust gas system of the motor vehicle.

10. The heat exchanger as set forth in claim 1, wherein the exchanger tube is substantially made from one piece between points at which the exchanger tube forms a seal with the housing.

11. The heat exchanger as set forth in claim 1, wherein the exchanger tube is curved in a substantially U-shape between points at which the exchanger tube forms a seal with the housing.

12. The heat exchanger as set forth in claim 1, further comprising a plurality of exchanger tubes disposed in the housing, the tubes forming a bundle connected in parallel in terms of fluid flow.

13. The heat exchanger as set forth in claim 12, wherein the flow paths of the exchanger tubes have no contact to each other between respective inlets and outlets.

14. The heat exchanger as set forth in claim 1, wherein the exchanger tube is a smooth-walled tube.

15. The heat exchanger as set forth in claim 1, wherein the exchanger tube is a swirl tube.

16. The heat exchanger as set forth in claim 15, wherein the heat exchanger tube is widened in spirals.

17. The heat exchanger as set forth in claim 16, a winding distance of the spirals is between 1 and 15 millimeters.

18. The heat exchanger as set forth in claim 16, wherein a depth of the spirals is between 1 and 20% of an outer diameter of the exchanger tube.

19. The heat exchanger as set forth in claim 1, wherein a flow path extends in the exchanger tube, the flow path running as a winding flow path at least inside the housing and including an angle of rotation of at least 135°.

20. The heat exchanger as set forth in claim 1, wherein the exchanger tube has an outer diameter between 1 and 15 millimeters.
